(19) United States
(12) Patent Application Publication
(10) Pub. No.: US 2001/0052654 A1
(43) Pub. Date: Dec. 20, 2001

(54) Concrete product molding machines and methods of making and operating the machines

(76) Inventors: Samuel L. Saddler, Alpena, MI (US); Kurt H. Korpela, Alpena, MI (US); William F. Wallis, Alpena, MI (US); Arnold G. Gengerke, Alpena, MI (US); Rodney D. Lang, Alpena, MI (US)

Correspondence Address: Reising, Ethington, Barnes, Kisselle,, Learman & McCulloch, P.C., 5291 Colony Drive North, Saginaw, MI, 48603, US

(21) Appl. No.: 09/733,414

(22) Filed: Dec. 8, 2000

Related U.S. Application Data
(60) Provisional application No. 60/170,315, filed on Dec. 13, 1999.

(51) Int. Cl. B29C 43/22

(52) U.S. Cl. 264/71; 264/333; 264/336; 425/432

(57) ABSTRACT

A concrete product molding machine supports a vibratable mold having an open top and an open bottom. A stripper head is movable from a position above the mold to an intermediate position ready to strip the molded product from the mold and then on to a lower position in which it has. A pallet receiver is movable from a lower position to a mold closing position in which a pallet it carries closes the bottom of the mold. Disengageable linking mechanism is provided for coupling the striper head and pallet receiver frame for conjoint travel in movement of the stripper head through the mold. A connector assembly connects with a pallet receiver lift arm and incorporates an actuator for varying the position of the upper end of the lift arm and thereby varying the vertical position of the pallet receiver.

This application claims the priority of U.S. provisional application Ser. No. 60/170,315 filed Dec, 13, 1999.

### BACKGROUND OF THE INVENTION

This invention is particularly concerned with concrete product molding machines having replaceable molds which are open at their upper and lower ends and incorporate mold vibrating devices. Pallets for closing the lower ends of the molds are supported on a pallet receiver which is movable up to cause the pallet to close the lower end of the mold and lift it slightly from its mold supports. Following charging of a concrete mix to the upper end of the mold and vibration to compact the wet concrete mix material in the mold in the usual manner, the stripper head is moved downwardly through the mold cavity at the same time the pallet receiver mechanism is moved downwardly to conjunctively strip the molded product from the mold.

Molding machinery of this general character is well-known and disclosed, for example, in the present assignee's U.S. Pat. Nos. 3,545,053; 3,963,397; 4,235,580; and 5,952,015, all of which are incorporated herein by reference. In these machines, the pallet receiver moves upwardly far enough to lift the mold off the mold support arms, prior to the time vibration is initiated. The pallet receiver is provided with resilient members which support the pallet and isolate the vibration.

### SUMMARY OF THE INVENTION

The present invention is concerned with certain improvements in machinery of the character mentioned which greatly improve the overall operation of the machine. Where previously the stripper head frame and pallet receiver were independently moved downwardly during the product stripping operation in the present assignee's cam-controlled machines, unique mechanism now clamps the stripper head assembly and the pallet receiver assembly for conjoint movement as an integrated body during the stripping stroke. In addition, the linkage mechanism for moving the pallet receiver is, in the new machine, substantially infinitely variable to provide the exact stroke which the pallet receiver requires for a particular mold producing a product of a predetermined height.

In the method of practicing the present invention, the stripper head moves downwardly after the charge of wet concrete mix has been delivered to the mold in the usual manner and the charge delivery member or feed box is removed. The stripper head frame is moved downwardly a predetermined distance for the stripper shoes to effectively reach the stripping position. Thereafter, the stripper head assembly and pallet receiver assembly are effectively clamped together and the vibration is initiated. After a predetermined time interval for densification of the mix to occur, the stripper head is carried downwardly by the pallet receiver until the stripper shoes are a predetermined distance below the mold. At this time, the stripper head assembly is unclamped from the pallet receiver, which continues to move the pallet and molded product downwardly, while the stripper head assembly returns upwardly. In the novel machinery illustrated, the pallet receiver cam mechanism controls the stripper head assembly which effectively decouples from the stripper head cam mechanism to permit the pallet receiver assembly to move the stripper head downwardly under its control during the stripping operation. An independent return assembly is utilized to return the stripper head upwardly to a position in which its movement is again controlled by the stripper head cam mechanism.

During the operation of such machines, a number of different products are normally manufactured on the machine in production runs of varying duration and the molds are changed to produce products such as concrete blocks, for example, of varying height and other dimension. It is to be understood that the machines for producing such relatively heavy concrete products are very large and that the molds, for example, may weigh in the neighborhood of 4,000 pounds. Typically, a product molding cycle is required to be completed in a matter of seconds.

Where the inner frame of the prior art machine, which carries the mold, needs to be adjusted to accommodate replacement molds producing varying product heights and there is a spring gap to adjust because the stripper head and pallet receiver do not always travel at precisely the same speed, the inner frame of the new machine needs to be adjusted to only two positions because the pallet receiver stroke itself is virtually infinitely adjustable to control the stroke of the pallet receiver.

One of the prime objects of the present invention is to provide an improved machine which operates in a more precise manner to achieve improved molding results.

Another object of the invention is to provide a machine which is better adaptable to the production of products of different heights and requires less machine down-time for changeover.

Another object of the invention is to provide a high production, concrete product molding machine incorporating improvements which speed up the production process.

Still a further object of the invention is to provide a very durable, heavy duty machine which has lower maintenance costs.

Still a further object of the invention is to provide a machine which provides homogenous products of high quality in a rapid and efficient manner.

Other objects and advantages of the invention will become apparent with reference to the accompanying drawings and the accompanying descriptive matter.

### GENERAL DESCRIPTION OF THE DRAWINGS

The presently preferred embodiment of the invention is disclosed in the following description and in the accompanying drawings, wherein:

FIG. 1 is a schematic front elevational view of machine elements which are also embodied in a prior art machine with the stripping head in raised position and certain components omitted in the interest of clarity;

FIG. 2 is a similar schematic side elevational view thereof with certain parts being omitted in the interest of clarity, the view in this case being taken with the stripper head in a lowered position;

FIG. 3 is a partly schematic front elevational view of a similar prior art machine, again with certain component parts being omitted in the interest of clarity;

FIG. 4 is a schematic front elevational view of the machine of the present invention, again with a number of component parts omitted in the interest of clarity;

FIG. 5 is a schematic front elevational view of certain components of the improved machine;

FIG. 6 is an enlarged schematic front elevational view of the grab and release clamp assembly which unites the stripper head and the pallet retainer at a certain time during operation of the machine;

FIG. 7 is a side elevational view thereof;

FIG. 8 is a greatly enlarged, schematic sectional elevational view showing a clamp mechanism used with the grab and release clamp assembly in released position;

FIG. 9 is a similar view showing the clamped position of the component parts;

FIG. 10 is an enlarged schematic side elevational view of the gas spring return assembly for restoring the stripper head to its control cam;

FIG. 11 is an enlarged schematic partly sectional fragmentary end elevational view showing one of the pallet receiver cam follower arms and illustrating an analog connector arm assembly which links to the pallet receiver;

FIG. 12 is a fragmentary front elevational view thereof;

FIG. 13 is a fragmentary top plan view thereof;

FIG. 14 is a reduced size end elevational view of the follower arm and connector arm mechanism;

FIG. 15 is a front elevational view thereof; and

FIG. 16 is a schematic control diagram illustrating only certain components of the control circuitry in the interest of clarity.

### DETAILED DESCRIPTION OF THE DRAWINGS

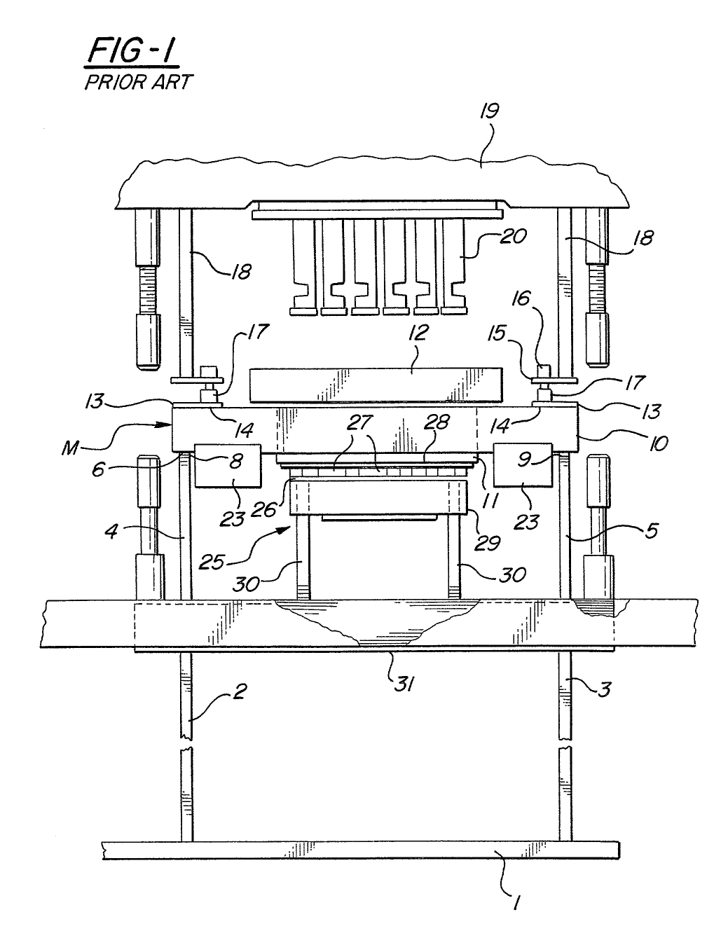

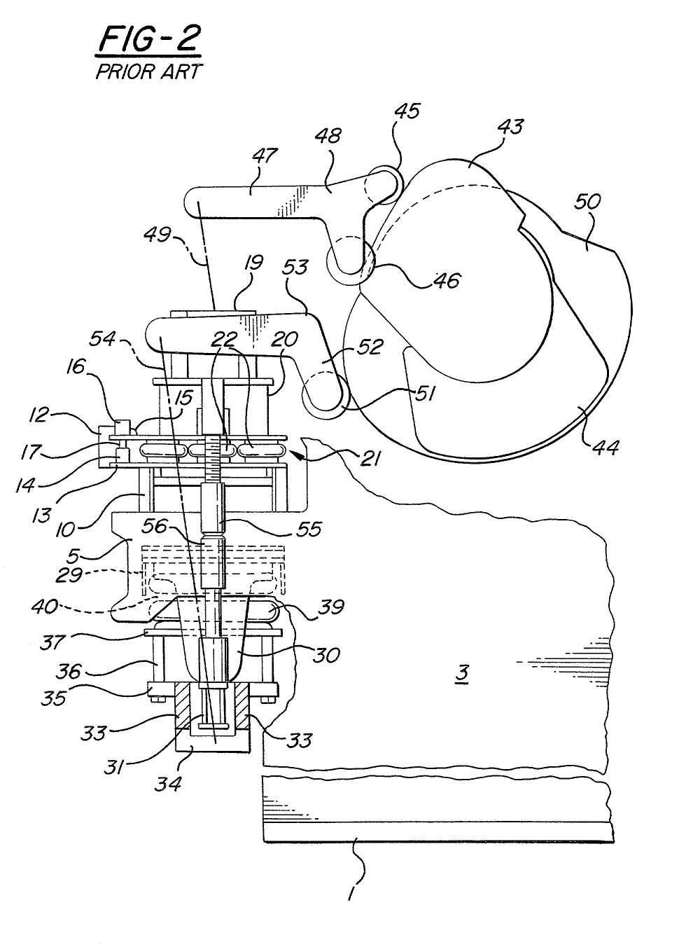

Referring now more particularly to the drawings, and in the first instance to FIGS. 1 and 2, for a general disclosure of a concrete product or block making machine of the character involved in the invention, a base 1 is shown as provided with an upstanding frame including spaced apart frame members 2 and 3. The frame members 2 and 3 shown are the so-called inner frame members which are mounted on outer frame members (not shown) fixed to the base 1, and which have some vertical sliding adjustment thereon. Between their upper and lower ends, the frame members 2 and 3 have forwardly projecting mold supporting arms 4 and 5, respectively, on which the mold, generally designated M, is supported, before the molding operation takes place, on throat surfaces 6 and 7 which have flat horizontal support surfaces 8 and 9.

Spanning the throats 6 and 7 and supported upon the surfaces 8 and 9 when the machine is at rest, is the frame 10 of the mold M, which has an open top and an open bottom, as usual. The interior of the mold M is shaped to correspond to the block or product, or a plurality of the blocks or products, being molded, and a shroud 12 is carried by the mold member 10 and surrounds the open top of the mold M. At opposite ends of the mold frame 10, are secured a pair of fore and aft extending base or lower plates 13. At the forward end of each plate is fixed a bushing 14. Parallel to, but spaced above each plate 13, is a corresponding upper plate 15 at the forward end of which is fixed a block 16 from which a guide pin 17 extends to be slideably accommodated, and held so as to be laterally restrained, in the companion bushing 14. Upper plates 15 are secured to the lower ends of vertical supports 18, which constitute parts of the machine frame, and form slide guides for a stripper frame or frame assembly 19, which is vertically reciprocable in the usual manner thereon.

The vertically moving stripper frame 19, which can be driven vertically by a cam, supports a stripper head 20, with shoes which are of such size and shape as to fit snugly but slideably within the mold's cavity 11. The mold frame 10 normally rests upon the surfaces 8 and 9 of the throats 6 and 7, but is capable of vertical vibrating movement when pushed upwardly off the surfaces 8 and 9, and is guided in such movement by the guide pins 17. As is conventional, the mold frame 10 may be fitted with motor driven vibrators, diagrammatically shown at 23, for the purpose of vibrating the mold M and densifying the concrete mix charge, which is supplied thereto.

The molding machine includes a pallet support or receiver 25 comprising an upper plate 26 fitted with resilient pads 27, atop which a metal pallet 28 may be supported to form a removable bottom for the mold M. The upper plate 26 has a depending skirt 29 within which is accommodated the upper end of a pair of downwardly tapering support arms 30. The upper ends of the arms 30 are fixed to the plate 26 and the lower ends of the arms are welded to a transverse pallet receiver beam or frame, generally designated 33, which spans the frame members 2 and 3 at the front of the machine. The arms 30 and the beam 33 thus are movable vertically as a unit in a manner for a purpose presently to be explained. The beam 33 constitutes a motion transmitting means for the pallet receiver plate 26 and its associated structure.

The vertical movements of the stripper frame 19 and the pallet receiver frame 33 may be effected by the cam controlled conventional drive means illustrated diagrammatically in FIG. 2. The drive means for the stripper frame at each end of the machine comprises a pair of motor driven cams 43 and 44, which are engagable and disengagable with a pair of followers 45 and 46, respectively, journaled at one end of a bell crank 47 that is pivoted as at 48 to the machine frame. A shaft 48 is carried by the frame. The opposite end of the crank 47 is pivotally connected, as at 47a, by linkage 49 to the stripper frame 19 to effect upward and downward vertical movements of the latter according to the contours of the cams 43 and 44.

The drive means for the pallet receiver frame 33 at each end of the machine comprises a motor driven cam 50 in engagement with the follower 51, journaled at one end of a bell crank 52, that is pivoted to the machine frame at 53. The opposite end of each crank 52 is pivotally connected at 54a to the linkage 54 which connects to the pallet receiver frame 33.

As is conventional, the stripper frame 19 and the pallet receiver frame 33 are provided with confronting pairs of adjustable stops 55 and 56 at each end of the machine operable to limit relative movement of such frames toward one another for the purpose of controlling the height of the block or product formed in the mold 11. After filling of the mold by a feeder device, clamping of the pallet 28 to the bottom of the mold and the lifting of the mold off the throats by a slight continued upward movement of the pallet receiver 33, the stripper head frame is lowered to bring the stripper shoes into contact with the mix in the mold and the vibrators 23 are operated to-vibrate the mold frame, thereby effecting even distribution and compaction of the concrete mix throughout the mold 11.

With engagement of the height stop members 55 and 56, vibration of the mold is discontinued and there is an independent downward movement of the stripper head and the pallet receiver a distance sufficient to enable the molded block to be pushed through the mold to a level below that of the bottom of the mold. Thereafter, the stripper head frame 19 and the receiver frame 33 are restored upwardly and downwardly, respectively, to initial position by their respective cams.

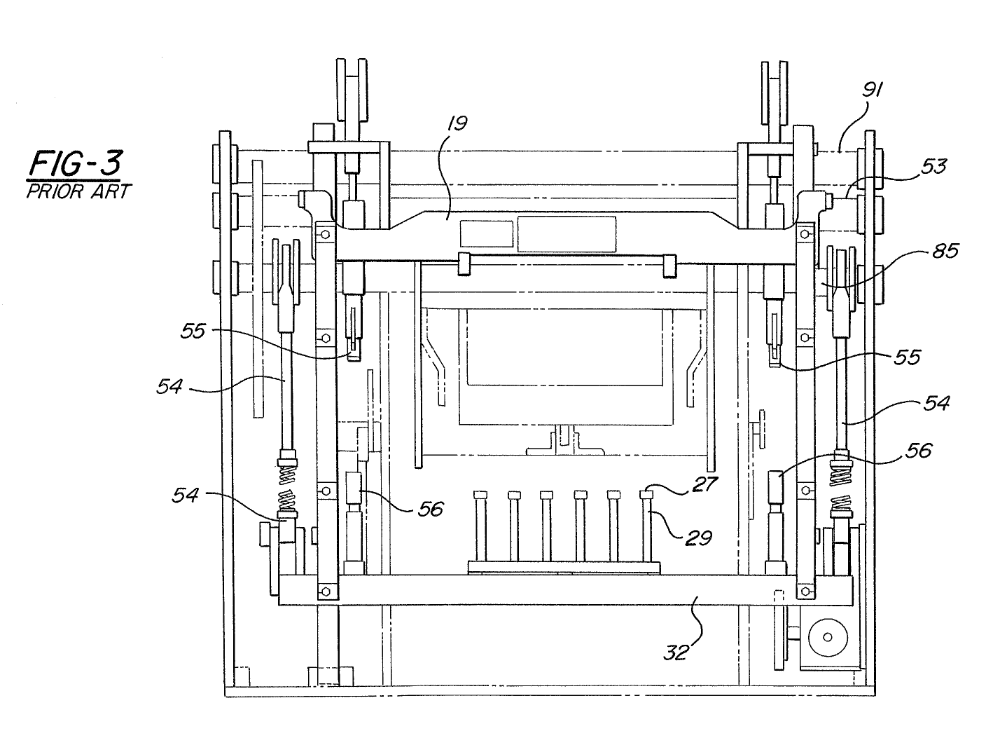

In FIG. 3, a more recent prior art machine, which those skilled in the art will recognize as the present assignee's ULTRAPAC® machine, is shown in which similar parts have been given the same numbers, as previously. This improved prior art machine depicted operates generally in the same manner as the prior art machine illustrated in FIG. 1 and 2.

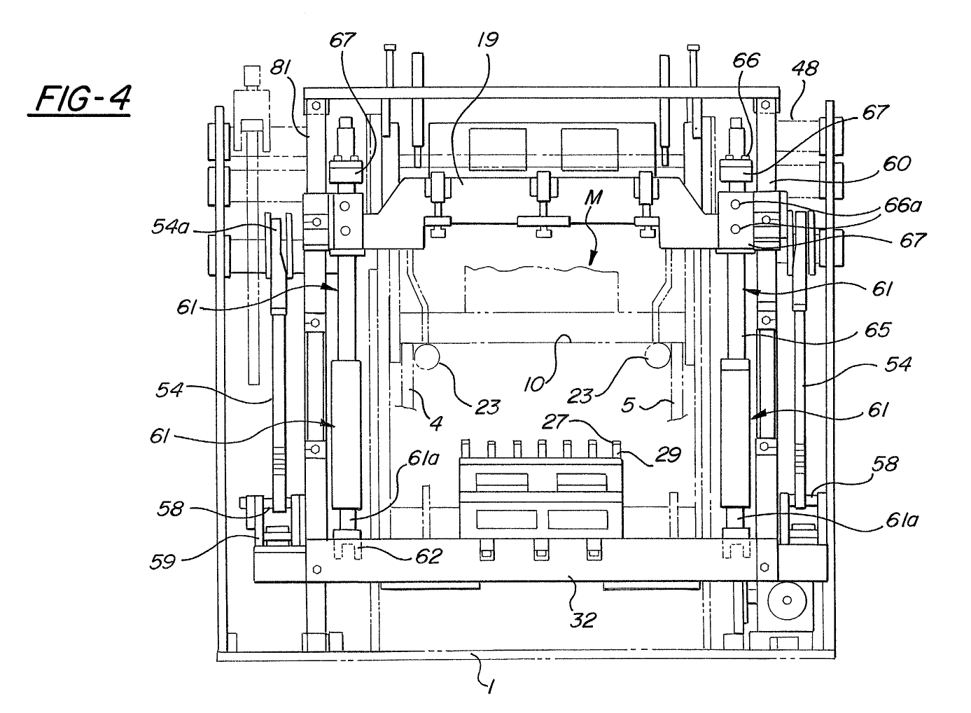

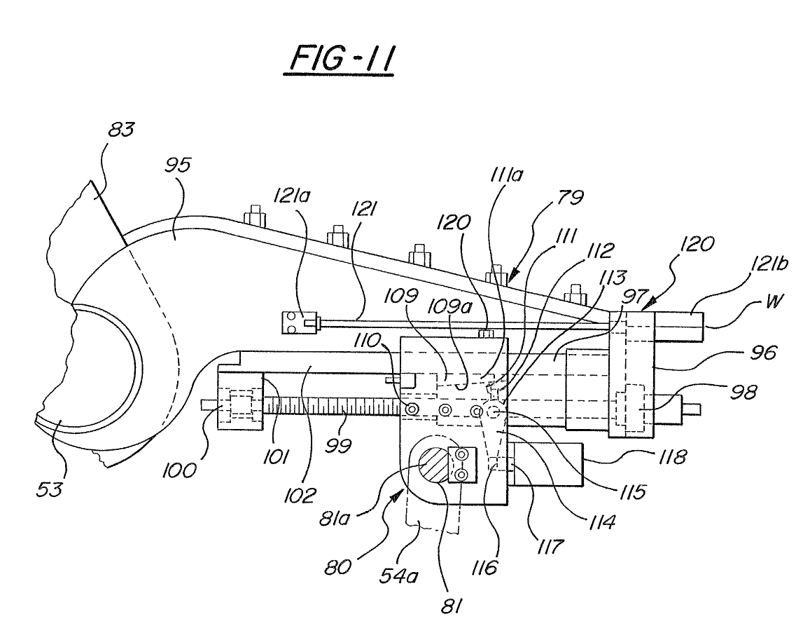

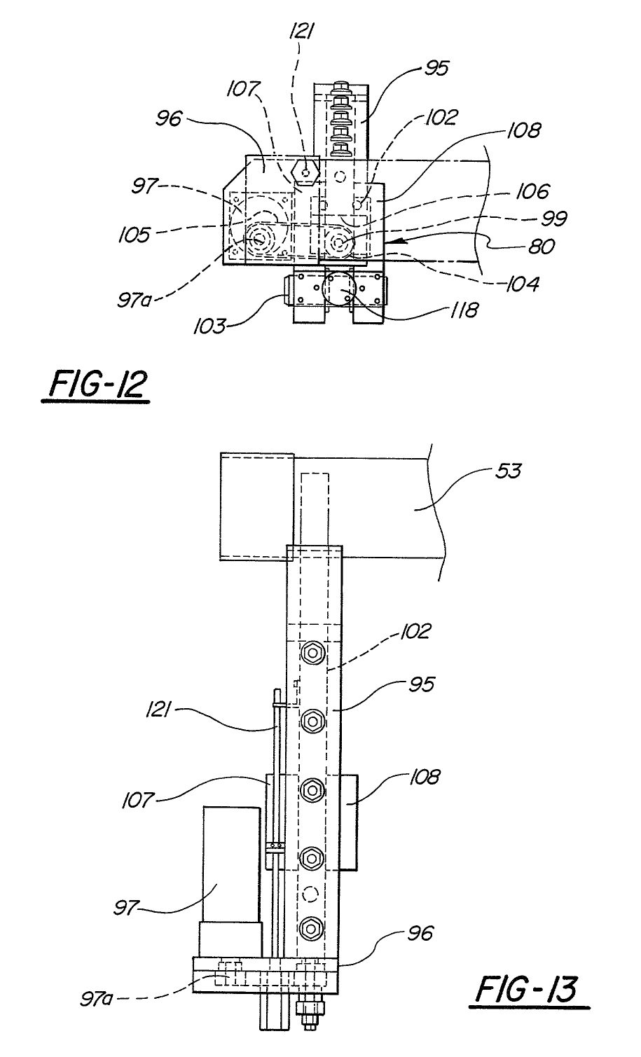

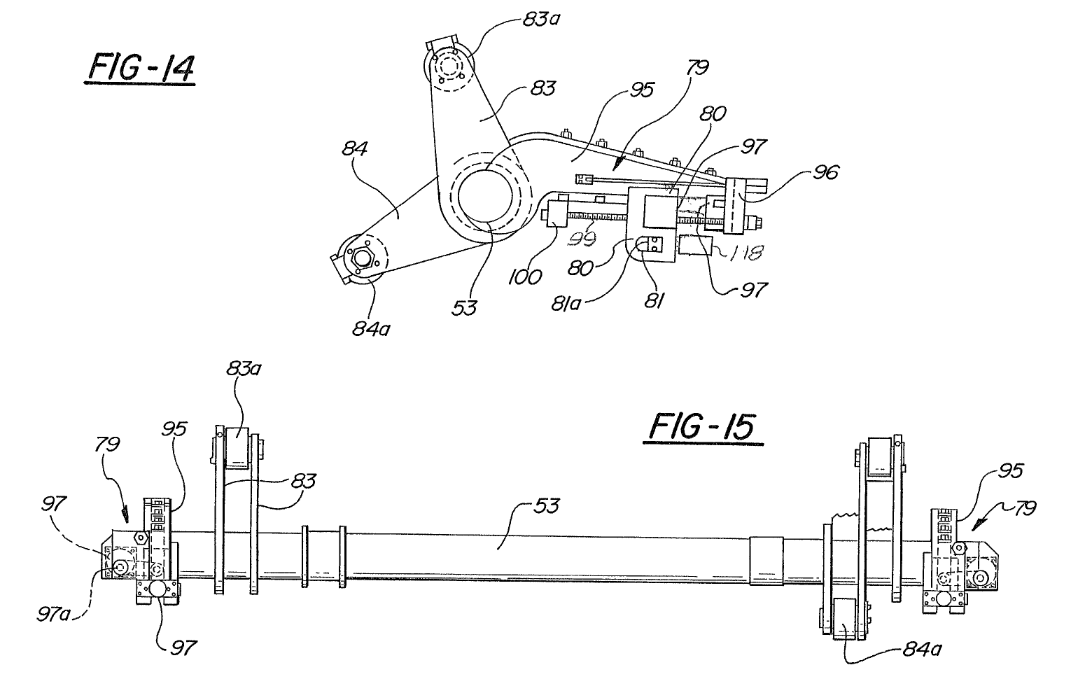

In FIGS. 4-17, a molding machine is illustrated which incorporates the prior art elements and the improvements which form the subject matter of the present invention, and the like parts illustrated in FIGS. 1-3 and in FIGS. 4-17 have been given identical numbers. A number of the conventional components have been omitted, or simply not numbered, in the interest of clarity. However, a mold M is schematically illustrated in FIG. 4 supported on arms 4 and 5 and includes vibratory mechanisms V for vibrating the mold which may be of the type disclosed in U.S. Pat. No. 4,978,488, for example.

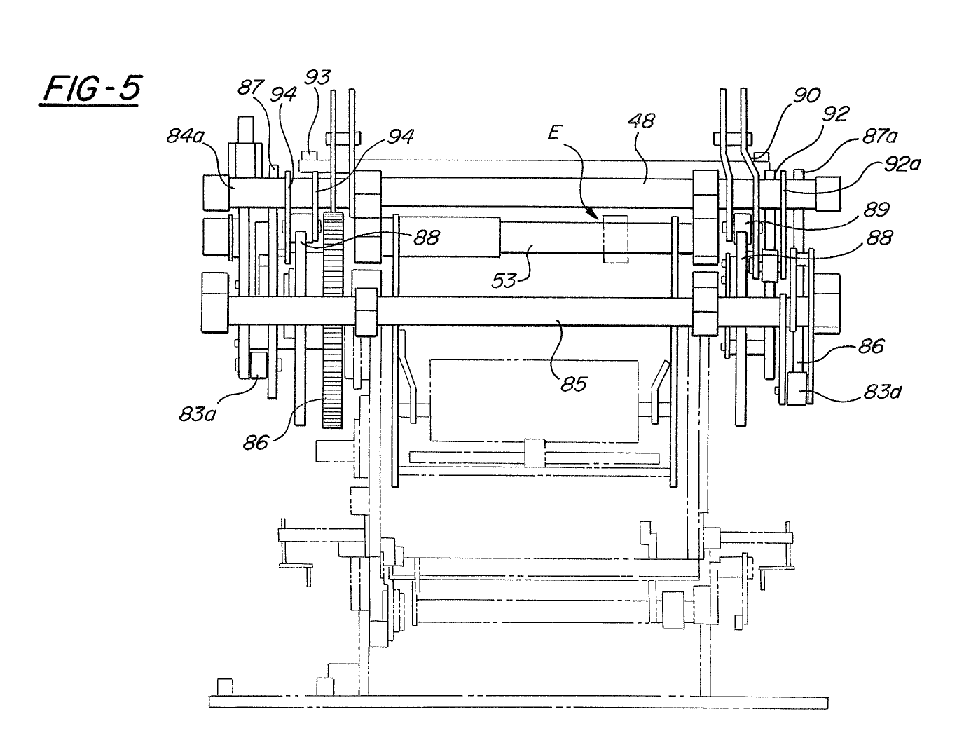

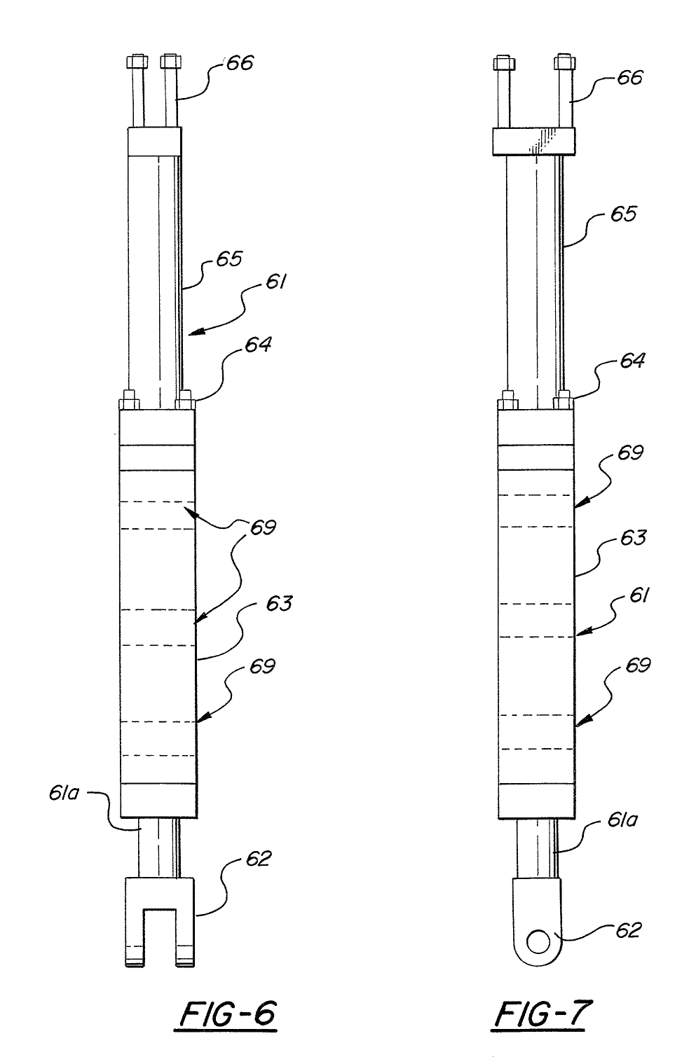

It will be noted in FIG. 4 that the pallet receiver control link 54 at each end of the machine is attached to a pin 58 supported by a clevis 59 which secures to the pallet receiver frame 33 and that the stripper frame 19 and pallet receiver 33 are guided in upper and downward movement in the usual manner. As was noted earlier, during both the vibrating and the stripping operations, the stripper head assembly 19 and the pallet receiver 33 are rigidly mechanically linked for conjoint travel during a portion of their vertical downward movement in the present machine. The grab and release clamp assembly for accomplishing this is particularly indicated at 61 in FIG. 4 and, more particularly, illustrated in FIGS. 5 and 6. It may also be referred to as a linking mechanism or a coupling mechanism.

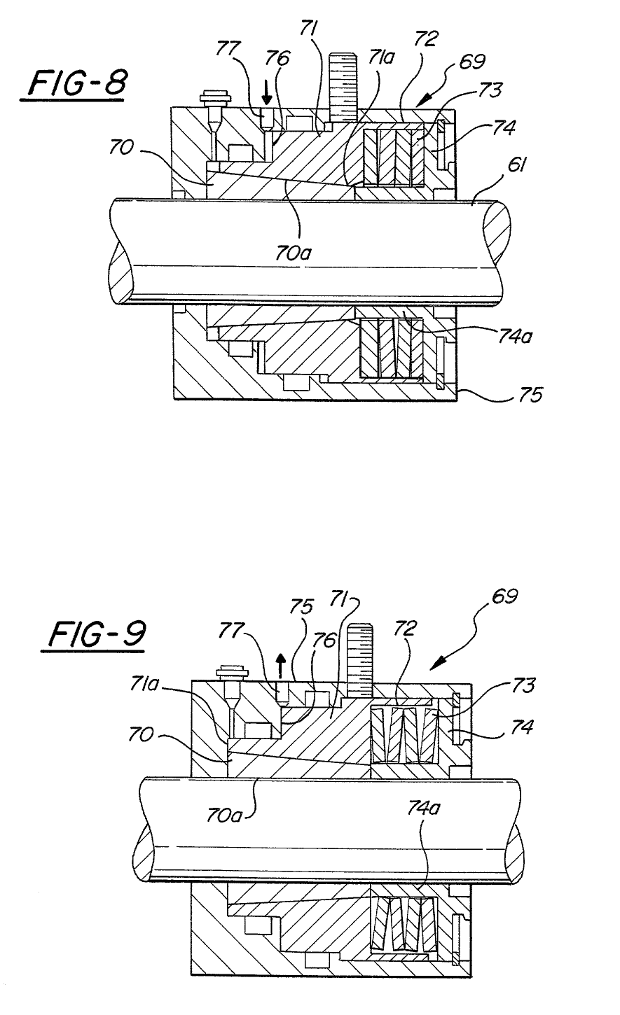

As FIGS. 6 and 7 particularly show, the clamp assembly 61 at each end of the machine telescopically receives a rod, generally designated 61a, which, at its lower end, is provided with a clevis 62. The rod 61a passes into a squeeze cylinder 63. Fixed to the squeeze cylinder, as by bolts and nuts 64, is an extension or spacer cylinder 65, which may be affixed to the stripper head assembly with bolts 66a, fixing to a block 67 on the stripper head assembly as shown in FIG. 4. Housed within each squeeze cylinder 63 are a trio of conventional rod clamps, generally designated 69 and illustrated schematically by diagrammatic lines in FIGS. 6 and 7. FIGS. 8 and 9 shown the clamped and unclamped positions of the rod clamp mechanisms 69. It is to be understood that other rod clamp mechanisms are available and may be optionally used.

Referring more particularly to FIGS. 8 and 9, it will be seen that there is an axially fixed inner sleeve 70 through which the rod 61a freely passes when the device is in unclamped position as shown in FIG. 8. The sleeve 70 has a tapered outer surface 70a, which cooperates with the tapered inner surface 71a of an outer sleeve 71. Outer sleeve 71 has a coil spring well 72 within which a return coil spring 73 is disposed and it will be seen that the open end of well 72 is closed by end cover member 74 fixed to the rod clamp housing 75, member 74 having an inner end 74a forming the inner wall of the annular well 72 and abutting the end of sleeve 70. The axially movable sleeve 71 is received within a cylinder recess 76 provided in the housing 75 in which the movable sleeve or plunger 71 has a limited axial movement under the influence of hydraulic fluid admitted to it through a fitting 77. With hydraulic pressure applied, as shown in FIG. 8, the coil spring 73 is compressed by outer plunger sleeve 71 moving slightly to the right. In FIG. 9, the hydraulic fluid is bled off through the port 77, allowing the clamping spring 73 to move the outer sleeve 71 from right to left and pressure the inner sleeve 70 to clamp the rod 61 as shown in FIG. 9. As shown in FIG. 16, an electrically operated valve V can be used to supply and release operating fluid or the valve may be hydraulically operated. The retract solenoid of valve V is shown at 69a as energized by a switch contacts 69b and the forwarding solenoid is shown at G9c as energized by switch contacts 69a. While a trio of these rod clamps are utilized in the cylinder 63, the number used is not critical and a fewer or greater number of rod clamps of varying design may well be used. The clamps are readily commercially available.

As indicated previously, and as will be presently be further described, it is the pallet receiver 33 which operates to pull the stripper head 19 downwardly when the pallet receiver moves downwardly after the vibrating densification takes place. At this time, the rods 61a, at each side of the machine, are in the clamped position indicated in FIG. 9.

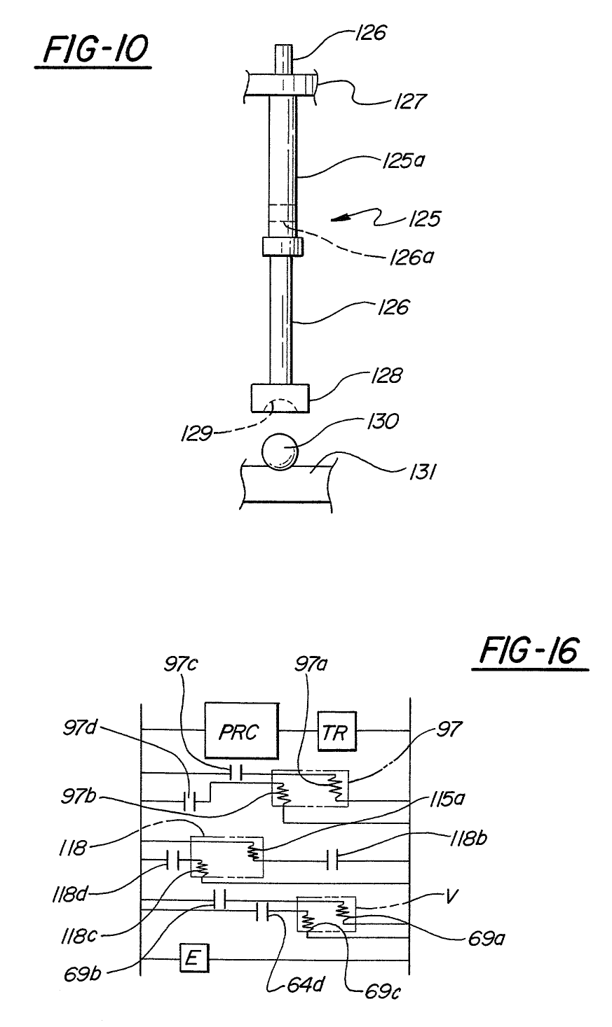

The link assembly used at each side of the machine includes link or lift arms for raising and controlling lowering of the pallet receiver is shown in FIG. 4 at 54. At their upper ends, the links have eye portions 54a, which are pinned to connector assemblies, generally designated 79 (FIGS. 11-15), which have dependent nut members, generally designated 80, with link attachment openings 81. Securing pins 81a extend through the eye openings in link portions 54a and the openings 81.

At their upper ends, the connector assemblies 79 connect with the pallet receiver controlling rotatable shaft 53 in the usual manner and it will be seen that the shaft 53 mounts a pair of follower arms 83 and 84 (FIG. 14), each of which has a follower roller 83a and 84a, respectively. The connector assemblies 79 are fixed to the pivot shaft 53 and the follower arms 83 and 84 also are fixed to the shaft 53 so that a constant angle between them is maintained. It is the connector arm assemblies 79 which in the present machine are linked to the pallet receiver 33. It should be understood that the terms pallet receiver drive device are broadly used to refer to mechanism for moving the pallet receiver frame and need not incorporate the connector arms and elements particularly described.

As FIG. 5 shows, the main cam shaft for driving the cams which operate the stripper head and pallet receiver is shown at 85, as driven by a suitable gear 86 from an appropriate hydraulic or other motor source. Mounted on the cam shaft 85 at each end are left hand and right hand conjugate cams 87 and 87a for controlling the pallet receiver assembly 33. Each will be engaged by one of the cam follower rollers 83a-84a.

Also shown as mounted on the cam shaft 85, are the cams 88 for controlling much of the movement of the stripper head via shaft 48, cams 88 being engaged by follower rollers 89 carried by follower arms 90 generally such as shown at 47 fixed on the stripper head control shaft 48. The terms stripper head drive device are broadly used to reference any mechanism used to move the stripper head and need not incorporate the elements particularly described. Also mounted on the cam shaft 85 is the pallet receiver raising cam 92, follower rollers 93 carried on follower arms 94 fixed to shaft 53 being engaged by the cam 92. The cams for controlling the pallet receiver may be collectively referred to as cam devices as may the cams for controlling the stripper head. The various cams and -follower arms will be similar in overall appearance to the cams shown in FIG. 2.

As FIG. 14 indicates, a connector assembly 79, in left-hand and right-hand configuration, is fixedly mounted on each end of the shaft 53. For purposes of convenience, only one of them need be described because they operate identically and have mirror identical parts. Directing attention now particularly to the left-hand connector assembly shown in FIGS. 11-15, the connector assembly includes an arm member 95 fixed to the shaft 53. Mounted at the outer end of the arm 95 is a block housing 96, which projects laterally and supports an electrically powered reversible gear motor 97 powering an output shaft 97a. The block housing 96 provides a bearing 98 for supporting one end of a screw shaft or screw 99, whose opposite end is supported by a bearing structure 100 carried by a bracket member 101 joined to arm 95 by support 102. Screw 99 may be broadly referenced as providing a track for a nut or movable member Pulleys 103 and 104 are mounted in the housing 96 on shafts 97a and shaft 99 and, via a timing belt 105, transmit the rotary drive of reversible drive motor 97 into either clockwise or counterclockwise rotation of the screw shaft 99.

Mounted for travel on the axially fixed lead screw shaft 99 is the nut member 80 which carries the link 54 to the pallet receiver 33. The nut member 80 includes a central portion, with a threaded bore corresponding to the thread of the axially fixed lead screw 99, and a pair of track guides 107 and 108, movable along the track 102.

Carried by the nut body 80 is a fixed wedge member 109 (FIG. 11) having a lower tapered surface 109a, which is retained in fixed position by a stud member 110. Cooperating with the fixed wedge 109 to lock the nut body 80 in a given position on the screw 99 is a movable wedge 111 having an upper tapered surface 111a cooperating with the tapered surface 109a. The axially movable wedge 111 has an opening or recess 112 for receiving the upper end 113 of a lever 114, which is pivoted interjacent its ends as at 115, within member 80. At its lower end, the lever 114 is received in an opening 116 provided in the piston rod 117 of a double acting pressure fluid operated cylinder or motor 118, which operates to move the lever 114 back and forth and, therefore, also the moveable wedge member 111, to firmly lock the member 80 in a particular position on lead screw 99. As FIG. 16 indicates, cylinder 118 can have a forwarding solenoid 118a activated by switch contacts 118b, and a retract solenoid 118c activated by switch contacts 118d.

In order that the position of the nutlike member 80 on shaft 99 is known, a transducer assembly, generally indicated at TR, includes an electromagnetic marker part fixed on the member 80 for travel with respect to a transducer assembly waveguide rod 121 Rod 121 has an enlarged part 121a on its outer end and the transducer part 121b with cable W on its opposite end.

The transducer TR utilized is a linear displacement system utilizing magnetostrictive waveguide technology wherein the linear positioning of the floating marker 120a on the nut body 80 generates a signal whose value represents the absolute position of the marker component. The signal from transducer TR, which can be the Balluff transducer, Model No. BTL-2-E10-0390-2-SD24-532, is sent to the input card of a programmable controller PRC which decodes the miliamp signal to an integer value. In the present case, the magnetic marker 120a is moved with nut body 80 to a given position relative to the rod 121 in accordance with the output of the programmable controller PRC and the program or software incorporated in the controller which positions the transducer marker 120 via driving the motor 97, Other commercially available transducers of various types may also be used to create what may be termed an analog device.

The positioning of the nut device 80 to adjust to a different height mold and concrete block occurs in this manner with the single push of a start button for energizing the programmable controller and motor 97 to move marker 120a. The foregoing mechanism provides a virtually infinite adjustment of the pallet receiver 33 with the mere push of a button and replaces a system used by applicants' assignee for many years in which there simply were several spaced apart openings in the arm member 95 to which the pallet receiver link mechanism 54a could be variably manually attached.

Alternatively, to the transducer system employed, but considerably less preferable and with much less precision, it would be possible to manually jog the motor 97 to move the nut 80 and marker 120a relative to lead screw 99 to reach an appropriate position of the marker 120a with respect to a predetermined scale provided on the rod member 121.

To return the stripping head to the position in which it was initially clamped to the pallet receiver and then pulled downwardly are conventional gas springs located laterally adjacent to the gripping rods 61 and supported on the stripper head frame. As shown in Figure 10, the return mechanism may include a pair of conventional gas springs 125 at each end of the machine.

Each spring 125 comprises a cylinder 125a, having a piston rod 126, which fixedly secures to the stripper head assembly as at a stripper head bracket 127. Each piston 126 has a head portion 128 with a hemispherical cavity 129, which can receive a generally spherical member 130 fixed to one of the mold bars 131 at each side of the mold.

In normal position, each piston rod 126, which has an interior piston member 126a, is disposed in the position shown in solid lines. When the piston rods 126 are forced upwardly, due to movement of the gas spring cylinders 125 downwardly with the clamped stripper head assembly and pallet receiver, each cylinder 125a moves downwardly forcing its rod 126 upwardly relative to the cylinder body 125a and compressing the gas within the gas spring cylinder. Because of the ball joints 130, the tendency to transmit lateral vibration is obviated. Later, when the pallet receiver and the stripper head assembly are unclamped, the gas springs 125 restore the stripper head to the vertical position in which clamping originally occurred. The cam mechanisms controlling the stripper head are so configured as to move the head downward from a raised remote position to an intermediate position in which the head is ready to commence the mold stripping operation after vibration has occurred, to permit movement of the head down to its lower position, to permit restoration of the stripper head to intermediate position, and then take over to raise the stripper head from intermediate position to the removed initial upper position.

In FIG. 17, we have schematically illustrated a simplified electrical control circuit for various control elements. As shown, it provides a programmable controller PRC which activates the forward and reverse solenoids 97a and 97b of motor 97 which are actuated by switch contacts 97c and 97d respectively. In addition, the controller PRC is connected to the transducer circuitry TR and to the forwarding and retract solenoids of the locking cylinders 118. In the schematic diagram, for the sake of simplicity, we have shown only one of the motors 97, cylinders 118, and valves V. Also shown is a conventional commercially available resolver or encoder E used to monitor the rotary position of shaft 48, as will be described. The device, which may be the Allen Bradley Modal 846-SJDA2CK-R3 unit produces a set of voltages whose ratio represents the absolute position of the shaft. The signals are sent to an input card on the programmable controller via cable and decoded to an integer value. Other commercially available units may also be used.

### The Operation

Generally speaking, the machine of the present invention incorporates the same elements and operates in the same manner as the prior art machines, except where the method of operation is altered due to the improvements which have been disclosed herein.

The pallet receiver operates initially through the cams 92 and links 83 and 84 which turn shaft 53 to operate connection arms 79 to raise the linkage 54 and thereby the pallet receiver frame 33 and the pallet 11 thereon to close the bottom of the mold M. The upward movement is such as to raise the mold M a distance off the mold throat support surfaces 6 and 7 which is vertically greater than the amplitude of vibration of the mold when it is being vibrated Then the feedbox cam (not shown) is operated by cam shaft 85 to move the feedbox across to the upper end of the mold and charge the opening in the upper end of the mold with the wet concrete mix.

When the feedbox is withdrawn, the stripper head cams 88, via cam shaft 85, move the stripper head downwardly from the upper removed position via the stripper head link assembly 11 a predetermined distance until the encoder E on the stripper head shaft 91 indicates the stripper head shoes are in an intermediate position ready for stripping. They may be substantially in engagement with the concrete charge in the mold when the stripper head is in a vertical position to be clamped and the pallet receiver grab and release clamping assemblies 61 are in descended position to clamp rods 61a. The encoder E measures the degree of pivot of the shaft 48 on which the cam follower arms 90 are mounted. It would, of course, be possible to alternatively use sensors such as proximity switches to gauge when the stripper head assembly had moved vertically downwardly the required distance to be clamped by clamping assemblies 61. With vibration initiated, the concrete mix in the mold is densified and assumes the configuration of the mold. If desired, compaction of the mix in the mold can be assisted with conventional compaction assist members or plungers. When the conventional height adjustment pins shown in FIG. 4 at 55 and 56 come into contact, the stripping operation is commenced via the conjugate cams controlling the pallet receiver.

Prior to the commencement of vibration, the hydraulic valve V is electrically operated to back off the hydraulic pressure from each movable wedge 75 and permit each spring 73 in a clamping device 61 to move it from the unclamped position shown in FIG. 7 to the clamped position shown in FIG. 8. This will grip each rod 61 such that it forms a solid link between the striper head and the pallet receiver assembly. When the proper degree of compaction to proper product height is achieved, pins 55 and 56 will indicate it and activate the further pivoting of shaft 53 via the cam shaft 85. The pallet receiver conjugate cams cause the links 54 and the pallet receiver 33 to move downwardly and, at the same time, pull the stripper head assembly downwardly until such time as the stripper head shoes are a predetermined distance below the mold as measured by encoder E. With downward movement of the stripping head during this part of its stroke to its lower position effected by the pallet receiver 33, the stripper head shaft 48 is rotated by the downward movement so the encoder E actuator rotates with it. At this time, encoder E operates valve V so that hydraulic pressure is admitted by the valve V through the port 77 to power the movable wedge 76 in each clamping device 61 from the clamped position shown in FIG. 8 to the unclamped position shown in FIG. 7 and thereby release the rod 61a at each side of the machine.

The gas springs 125, which may be referenced as have been compressed during the lowering movement of the stripper head following vibration, then power the stripper head back up to the position in which it was initially clamped, whereupon the stripping head cams in effect take over to restore the stripper head assembly to its uppermost position ready to commence the next molding cycle.

When blocks of different height are to be molded, a minimum of set-up time is required to move the nut assembly, generally indicated at 80, to a new position to vary the stroke of the pallet receiver 33. First of all, activation of a switch 118d operates the retract solenoid 118c of cylinder 118 to move the link 114 in a retract direction to move the movable wedge 111 to an unlocked position. Movement of the nut assembly 80 along the lead screw 99 varies the position of the link opening 80 and the links 54 which connect with the pallet receiver 33 to alter the arc of swing transmitted to links 54. Movement of the link connection nut 80 is achieved by setting the controller PRC to initiate the desired height and then simply pressing the button which operates the motor 97 through the programmable controller PRC to bring the assembly 80 to its new position.

After the connection nut assembly 80 has reached the new position, the forwarding solenoid 118a of cylinder 118 is switch operated by contacts 118b to move pistons 117 inwardly and cause the links 116 to move the locking wedges 111 once again into locked position.

The disclosed embodiment is representative of a presently preferred form of the invention, but is intended to be illustrative rather than definitive thereof. The invention is defined in the claims.

We claim:

1. In a concrete product molding machine having a frame with mold supports, a vibratable mold thereon having an open top into which a concrete mix can be introduced and an open bottom through which the molded product can be removed, mechanism for vibrating said mold, a vertically movable stripper head having a shoe movable from a removed first position above said mold to an intermediate position ready to strip the molded product from the mold and on to a lower position in which it has stripped said molded product from said mold, a stripper head drive device for moving said stripper head to said intermediate position, a vertically moving pallet receiver frame supporting a pallet for closing said mold bottom movable upwardly from a removed lower position to a mold closing position in which the pallet closes the bottom of the mold when the mold is ready to be vibrated, and a pallet receiver drive device for vertically moving said pallet receiver frame, the improvement wherein:
a. disengageable linking mechanism is provided for coupling the stripper head and pallet receiver frame for conjoint travel in movement of the stripper head from said intermediate to said lower stripper head position; and
b. control mechanism for said linking mechanism is provided for coupling said stripper head and pallet receiver frame when the stripper head is in said intermediate position and decoupling them when said stripper head is in said lower stripper head position.

2. The machine of claim 1 wherein a cam shaft on said frame has cam devices for controlling raising and lowering movements of said pallet receiver frame and said stripper head, and said stripper head drive device for said stripper head includes a cam follower which disengages from said cam device controlling lowering of said stripper head to permit said stripper head to travel lower conjointly with said pallet receiver frame.

3. The machine of claim 2 wherein return mechanism, energized when said stripper head is moving downwardly conjointly with said pallet receiver frame, is positioned to restore said stripper head vertically to said intermediate position upon decoupling of said stripper head from said pallet receiver frame.

4. The machine of claim 1 wherein said pallet receiver drive device includes a cam follower on a pivot shaft controlled by one of said cam devices for raising and lowering said pallet receiver frame, said pallet receiver frame includes lift arms, and a connector assembly connects each said lift arm to be raised and lowered by said pivot shaft, said connector assembly having a movable link part for connecting to and varying the position of the upper end of the lift arm and thereby varying the vertical stroke of the lift arms.

5. The machine of claim 1 wherein said connector assembly includes a screw shaft and said movable link part comprises a nut movable along said screw shaft, and mechanism is provided for locking said nut in a given position on said screw shaft.

6. The machine of claim 5 wherein a reversible motor on said connector assembly revolves said screw shaft to move said nut upon command and said locking mechanism comprises a powered wedge coupled to a motor carried on said connector assembly.

7. The machinery of claim 1 wherein said disengageable linking mechanism comprises a clamping cylinder assembly extending telescopically between said stripper head and pallet receiver frame comprising a cylinder having a rod telescopingly extending into it and squeezing clamp mechanism within said cylinder movable from a first unclamped position to a second clamped position, there being a wedge member movable to one position to enable coupling of said cylinder and rod and to a second position to decouple them.

8. The machine of claim 7 wherein said wedge member is urged by spring pressure to said clamping position and by fluid under pressure to decouple them.

9. In a concrete product molding machine having a frame with mold supports, a vibratable mold thereon having an open top into which a concrete mix can be introduced and an open bottom through which the molded product can be removed, mechanism for vibrating said mold, a vertically movable stripper head having a shoe movable from a removed first position above said mold to an intermediate position ready to strip the molded product from the mold and on to a lower position in which it has stripped said molded product from said mold, a stripper head drive device for moving said stripper head to said intermediate position, a vertically moving pallet receiver frame supporting a pallet for closing said mold bottom movable upwardly from a removed lower position to a mold closing position in which the pallet closes the bottom of the mold when the mold is ready to be vibrated, and a pallet receiver drive device for vertically moving said pallet receiver frame, the improvement wherein:
a. said pallet receiver drive device including at least one lift arm with an upper end and a lower end connected to said pallet receiver frame, and a connector assembly with a movable member connected to the upper end of said lift arm, there being a track for said member along which said member is movable to vary the position of the upper end of the lift arm and thereby vary the vertical stroke of the lift arm.

10. The machine of claim 9 wherein said track is a screw, said connector assembly mounts a first motor for revolving said screw, and said movable member is a nut movable along said screw.

11. The machine of claim 10 wherein said connector assembly includes a wedge operated locking mechanism for fixing said nut in a particular axial position on said screw and carries a second motor for activating and deactivating the locking mechanism.

12. The machine of claim 11 wherein said connector assembly carries a transducer for signaling the position of said nut on said screw and a programmable controller operates the first motor to move said nut to a particular position dependent on the height of the product to be molded.

13. The machine of claim 12 wherein disengageable linkage mechanism is provided for automatically coupling said stripper head with said pallet receiver frame when said mold is ready to be vibrated for conjoint travel with said pallet receiver frame downwardly thereafter to a mold stripped position, there being mechanism for then automatically decoupling said stripper head from said pallet receiver frame.

14. The machine of claim 13 wherein said disengageable linkage mechanism comprises at least one fluid pressure operated squeeze cylinder with a rod extending through it to attach between said stripper head and said pallet receiver frame, and with a wedge operated clamping system within said cylinder for clamping and unclamping said rod, there being at least one gas spring compressed during said conjoint movement for returning said stripper head upwardly when it is decoupled.

15. A method of constructing a concrete product molding machine having a frame with mold supports, a vibratable mold thereon having an open top into which a concrete mix can be introduced and an open bottom through which a molded product can be removed, mold vibrating mechanism, a vertically movable stripper head having a part movable from a removed first position above said mold to an intermediate position ready to strip the molded product from the mold and on to a lower position in which it has stripped the molded product from the mold, a stripper head drive device for moving the stripper head to said intermediate position, a vertically moving pallet receiver frame supporting a pallet for closing the mold bottom movable upwardly from a moved lower position to a mold closing position in which the pallet closes the bottom of the mold before the mold is ready to be vibrated, and a pallet receiver drive device for vertically moving the pallet receiver frame comprising:
a. installing disengageable linking mechanism for coupling the stripper head and pallet receiver frame for conjoint travel and movement of the stripper head from said intermediate to said lower stripper head position under the control of said pallet receiver frame; and
b. providing control mechanism for said disengageable linking mechanism for coupling said stripper head and pallet receiver automatically when the stripper head is in said intermediate position and automatically decoupling said stripper head and pallet receiver when said stripper head is in said lower stripper head position.

16. The method of claim 15 wherein members operating independently of said disengageable linking mechanism are provided for returning said decoupled stripper head upwardly to said intermediate position in which coupling was effected.

17. A method of constructing a molding machine for concrete products having a frame with a vibratable mold supported thereon, the mold having an open top into which a concrete mix can be poured and an open bottom through which a molded product can be removed, mechanism for vibrating said mold, a vertically movable stripper head having a mix contacting member movable from a remote first position above said mold to an intermediate position ready to strip the molded products from the mold and then on to a lower position in which it has stripped said molded product from said mold, a drive device for moving said stripper head initially to said intermediate position, mechanism for vibrating said mold, a vertically moving pallet receiver frame supporting a pallet for closing said mold bottom movable upwardly from a removed lower position to a mold closing position in which the pallet closes the bottom of the mold when the mold is ready to be vibrated, and a pallet receiver device for vertically moving said pallet receiver frame, the steps including:
a. providing vertically extending link arms with an upper end and a lower end and connecting the lower end to said pallet receiver frame;
b. providing a connector assembly as a part of said pallet receiver drive device which has a movable member connected to the upper end of said link arm, said connector assembly being provided with a longitudinal track for said movable member along which said member is movable to vary the position of the upper end of the link arm and thereby vary the vertical stroke of the link arm.

18. The method of claim 17 wherein said track is provided as a screw and said movable member as a nut member movable along said screw, and a motor is provided for revolving said screw to move said nut member.

19. A method of operating a concrete product molding machine having a frame with a vibratable mold supported thereon, said mold having an open top into which a concrete mix can be supplied and an open bottom from which the molded product can be removed, vibrating mechanism for the mold, a vertically movable stripper head with a stripping shoe movable from a removed first position spaced above said mold to an intermediate position ready to strip the molded product from the mold and then on to a lower position in which said shoe has stripped said molded product from said mold, a stripper head drive device for moving said stripper head to said intermediate position, a vertically moving pallet receiver frame supporting a pallet for closing said mold bottom movable vertically upwardly from a remote lower position to a mold closing position in which the pallet closes the bottom of the mold before the mold is ready to be vibrated, a pallet receiver drive device for vertically moving said pallet receiver frame, disengageable linking mechanism for coupling the stripper head and pallet receiver frame for conjoint travel during movement of the stripper head from said intermediate to said lower stripper head position, and control mechanism for said linkage mechanism for coupling said stripper head and pallet receiver frame when the stripper head is in said intermediate position and decoupling them when said stripper head is in said lower stripper head position; the steps of:
a. operating said stripper head drive device to move said stripper head downwardly to said intermediate position;
b. activating said disengageable linking mechanism to couple the stripper head and pallet receiver frame;
c. moving said pallet receiver frame downwardly and thereby moving said stripper head from said intermediate to said lower stripper head position to strip said product from the mold;
d. unlocking said linking mechanism to decouple said stripper head and pallet receiver frame; and
e. returning said stripper head upwardly to said intermediate position and on to said first position.

20. A method of operating a concrete product molding machine having a frame with mold supports, a vibratable mold thereon having an open top for the introduction of a concrete mix and an open bottom through which the molded product can be removed, a vertically movable stripper head having a stripper body movable from a removed first position above said mold to an intermediate position ready to strip the molded product from the mold and on to a lower position in which it has stripped said molded product from said mold, a stripper head drive device for moving said stripper head to said intermediate position, a vertically moving pallet receiver frame supporting a pallet for closing said mold bottom movable upwardly from a removed lower position to a mold closing position in which the pallet closes the bottom of the mold before the mold is filled with a concrete mix, a pallet receiver drive device for vertically moving said pallet receiver frame, at least one lift arm with an upper end and a lower end connected to said pallet receiver frame, and a connector assembly included with said pallet receiver drive device having a movable member connected to the upper end of said lift arm and a track for said member along which said member is movable to vary the position of the upper end of the lift arm and thereby vary the vertical stroke of the lift arm,
a. a moving said movable member along said track to a predetermined position for manufacturing a product of predetermined height; and
b. moving locking mechanism from an unlocked position into engagement with said movable member to lock it in fixed position.
